(19) United States
(12) Patent Application Publication
(10) Pub. No.: US 2023/0038281 A1
(43) Pub. Date: Feb. 9, 2023

(54) CONTAINER FOR IMMERSION BLENDER

(71) Applicant: Vita-Mix Management Corporation, Olmsted Township, OH (US)

(72) Inventors: Jack W. Gee, II, Willoughby, OH (US); Matthew Dugan, Medina, OH (US); David J. Kolar, Stow, OH (US)

(21) Appl. No.: 17/396,342

(22) Filed: Aug. 6, 2021

(51) Int. Cl. A47J 43/07; A47J 43/044

(52) U.S. Cl. CPC A47J 43/0727; A47J 43/044; A47J 2043/04409

(57) ABSTRACT

Provided is a blending system, including a blending container for use with an immersion blender. The blending container may include curved or domed bottom surface that extends into a cavity of the container and that is configured to engage with the bell of the immersion blender. The blending container may prevent one or more of: splashing of foodstuff during the blending process, suction of the immersion blender to a bottom of the container during use, or cavitation of the foodstuff. The containers may direct foodstuff within the container or towards the immersion blender to prevent splashing and facilitate mixing of foodstuff. The blending container may further include an annular shoulder that tapers inwardly from a sidewall of the container to an open end.

### TECHNICAL FIELD

The present teachings relate to a blending system, and more particularly to a blending container for use with an immersion blender.

### BACKGROUND

Hand-held kitchen appliances may include immersion blenders, frothing devices, whisking devices, or any other attachment suitable for a motorized kitchen appliance. Immersion blenders (sometimes referred to as “stick blenders” or “wand blenders”) are hand held kitchen appliances that have rotary cutting blades that are immersed in a substance to be blended. Immersion blenders facilitate food to be blended in, for example, a cooking vessel. Often, immersion blenders, as well as frothing devices, whisking devices, and other similar handheld kitchen appliances, have an elongated form with controls (e.g., on/off controls, speed setting controls, etc.) on one end of the elongated form. The other end includes a mixing element, such as blades, frothing attachment, whisking attachment, etc., that is connected to an electric motor via a drive shaft. An immersion blender may also include a bell (sometimes referred to as a “hood”) that defines a space within which the blades spin.

Immersion blenders can be useful to process food as such hand held kitchen appliances may be less bulky than traditional blenders having a base with a motor and a mixing container, selectively attachable to the base, with an operable mixing blade disposed therein and controlled by the motor. Immersion blenders may be sold or provided with a certain mating container, including, for example, single serving containers or cups. Immersion blenders may also be used with any container, cup, cooking vessel, or the like, that the user may own. For instance, a user may insert an immersion blender into a cooking pot containing foodstuff to make a sauce or soup, may insert the immersion blender into a drinking cup having ingredients for a smoothie, juice, or iced drink, or may insert the immersion blender into a serving bowl or dish to make a salsa, puree, etc. Generally, when using an immersion blender, a lid is not used during the blending process since the immersion blender is inserted through the mouth of the container or cup.

When an immersion blender or other hand held kitchen appliance is used with these mating containers or personal cups and vessels, splashing of the foodstuff during the blending or mixing process may occur as the user moves the immersion blender up and down. The immersion blender can also create suction to the bottom of the container or cup, which forces the blade of the immersion blender to the bottom of the container or cup and can impede blending. Likewise, such conventional containers and cups do not have a controlled way to direct ingredients toward the blades which makes blending inefficient, can cause cavitation, and can make the blending process messier as the user attempts to direct ingredients towards the blades by moving the immersion blender itself.

Current blending systems and immersion blenders often focus on the immersion blender itself and incorporate elements into the bell end or cutting blade of the immersion blender, for example, by incorporating shields or internal ribbing within the bell end of the immersion blender.

Therefore, a need exists for improved blender systems and blending containers for use with an immersion blender. A need exists for immersion blenders and containers that prevent one or more of: splashing of foodstuff during the blending process, suction of the immersion blender to a bottom of the containers during use, or cavitation of the foodstuff. Moreover, there is a need for immersion blenders and containers that are able to direct foodstuff within the container or towards the blade assembly to prevent splashing and facilitate mixing of foodstuff, as well as increase ease of use without relying on the user to constantly adjust and move the immersion blender up and down within the container during blending.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a blending container configured for use with an immersion blender. In an embodiment, the blending container may comprise a closed end, at least one sidewall, and an open end opposite the closed end. In an embodiment, the at least one sidewall may extend from a periphery of the closed end. In an embodiment, the closed end and at least one sidewall may form a cavity. In an embodiment, the open end may be configured to receive foodstuff and at least a portion of the immersion blender. In an embodiment, the at least one sidewall may further comprise at least one flute. In an embodiment, the at least one flute may extend from a first point at or near the closed end towards the open end of the blending container. In an embodiment, the closed end may include a concaved portion that extends from a periphery of the closed end into the cavity of the blending container.

In an embodiment, the at least one sidewall may have a first circumference near the closed end and a second circumference near the open end. In an embodiment, the first circumference may be different than the second circumference. In an embodiment, the first circumference of the at least one sidewall near the closed end may be smaller than the second circumference of the at least one sidewall near the open end.

In an embodiment, the at least one sidewall may taper inwardly toward the closed end of the blending container from a shoulder of the at least one sidewall. In an embodiment, the at least one sidewall may taper outwardly toward the open end of the blending container from the closed end.

In an embodiment, the at least one flute may extend toward a second point or a terminal point on the at least one sidewall. The second point or terminal point may indicate a predetermined capacity of the blending container. In an embodiment, the at least one flute may include a depression that extends from a periphery of the at least one sidewall toward a center axis of the blending container.

In an embodiment, the blending container may further comprise a protruding lip at the open end of the blending container. In an embodiment, the protruding lip may be configured to engage with a lid. In an embodiment, the concaved portion of the closed end may be configured to direct foodstuff toward a blade of the immersion blender. In an embodiment, the concaved portion may include contact points configured to engage a bell of the immersion blender. In an embodiment, the concaved portion may be configured to allow the bell of the immersion blender to rotate on the concaved portion in a ball and socket manner. In an embodiment, the blending container may be blow-molded.

Provided is a blending system. In an embodiment, the blending system may comprise the blending container and an immersion blender insertable into the blending container. In an embodiment, the immersion blender may comprise a blade and a bell surrounding at least a portion of the blade. In an embodiment, the concaved portion of the closed end may direct foodstuff toward the blade of the immersion blender. In an embodiment, the concaved portion may be configured to allow the bell of the immersion blender to rotate on the concaved portion in a ball and socket manner.

Provided is a blending container configured for use with an immersion blender. In an embodiment, the blending container may comprise a bottom surface having a curved portion, at least one sidewall, wherein the at least one sidewall may extend from the bottom surface and define a cavity and wherein the curved portion of the bottom surface may extend into the cavity, an open end opposite the bottom surface and including an annular rib, and an annular shoulder that may taper inwardly from the at least one sidewall to the annular rib. In an embodiment, the at least one sidewall may include two, three, four, five, six, seven, eight, nine, or ten sidewalls. In an embodiment, the at least one sidewall may include three, four, five, six, seven, eight, nine, or ten sidewalls.

In an embodiment, the at least one sidewall may have a first circumference and the annular rib may have a second circumference. In an embodiment, the first circumference may be larger than the second circumference.

In an embodiment, the annular shoulder may taper inwardly from the first circumference to the second circumference. In an embodiment, the annular shoulder may further comprise a curved portion and a tapered portion. In an embodiment, the curved portion may connect the at least one sidewall to the tapered portion and the tapered portion may connect the curved portion to the annular rib. In an embodiment, an angle between the tapered portion of the annular shoulder and at least one sidewall may be from 110-130 degrees as measured from an axis defined by the at least one sidewall. In an embodiment, a length of the tapered portion of the annular shoulder and the curved portion of the annular shoulder together may be from 10-20 mm. In an embodiment, the concaved portion may include contact points configured to engage the bell of the immersion blender.

### DESCRIPTION OF THE DRAWINGS

The present teachings may be better understood by reference to the following detailed description taken in connection with the following illustrations, wherein:

FIG. 1A is a perspective bottom view of an embodiment of a blending container in accordance with various disclosed aspects herein;

FIG. 1B is a perspective top view of an embodiment of the blending container of FIG. 1A in accordance with various disclosed aspects herein;

FIG. 1C is a side view of an embodiment of the blending container of FIG. 1A in accordance with various disclosed aspects herein;

FIG. 1D is a perspective bottom view of an embodiment of the blending container of FIG. 1A in accordance with various disclosed aspects herein;

FIG. 2A is a perspective bottom view of an embodiment of a blending container comprising an annular shoulder in accordance with various disclosed aspects herein;

FIG. 2B is a perspective top view of an embodiment of the blending container of FIG. 2A comprising an annular shoulder in accordance with various disclosed aspects herein;

FIG. 2C is a side view of an embodiment of the blending container of FIG. 2A comprising an annular shoulder in accordance with various disclosed aspects herein;

FIG. 3A is a perspective bottom view of an embodiment of a blending container comprising squared body in accordance with various disclosed aspects herein;

FIG. 3B is a perspective top view of an embodiment of the blending container of FIG. 3A comprising a squared body in accordance with various disclosed aspects herein;

FIGS. 4A-D are expanded views of an embodiment of a blending container having a an annular shoulder in accordance with various disclosed aspects herein;

FIG. 5A is a cross-sectional views of an embodiment of a blending container having a recessed bottom surface in accordance with various disclosed aspects herein;

FIG. 5B is a cross-sectional views of an embodiment of a blending container having a curved bottom surface in accordance with various disclosed aspects herein;

FIGS. 6A-B are cross-sectional views of an embodiment of a blending container having a curved bottom surface in accordance with various disclosed aspects herein;

FIG. 7 is a cross-sectional view of an embodiment of an immersion blender selectively inserted into an embodiment of a blending container having a curved bottom surface in accordance with various disclosed aspects herein;

FIG. 8A is a perspective top view of an embodiment of a lid configured to selectively engage with a blending container in accordance with various disclosed aspects herein;

FIG. 8B is a perspective top bottom view of an embodiment of the lid of FIG. 8A configured to selectively engage with a blending container in accordance with various disclosed aspects herein; and

FIG. 9 is a side view of an embodiment of a lid selectively attached to an embodiment of a blending container in accordance with various disclosed aspects herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to embodiments of the present teachings, examples of which are illustrated in the accompanying drawings. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that references to a blender, blender system, and the like, are understood to include other mixing systems. It is further noted that while various embodiments refer to an immersion blender or hand-held blender, various other systems and hand-held appliances may be utilized in view of embodiments described herein. For example, embodiments may be utilized in food processor systems, mixing systems, various other food preparation systems, home appliances, or other hand-held kitchen appliances using motors, such as frothers, hand-mixers, and electric whisks. As such, references to a hand-held blender, blending system, and the like, are understood to include the various other machines.

Furthermore, while blending of “ingredients,” “contents,” or “foodstuffs” is described by various embodiments, it is noted that non-food stuff may be mixed or blended, such as paints, epoxies, construction material (e.g., mortar, cement, etc.), and the like. Moreover, blending of ingredients may result in a blended product. Such blended products may include drinks, frozen drinks, smoothies, shakes, soups, purees, salsas, sauces, sorbets, butters or milks (e.g. nut or oat), dips or the like. Accordingly, such terms may be used interchangeably unless context suggests otherwise or warrants a particular distinction among such terms. Further, such terms are not intended to limit possible blended products and should be viewed as examples of possible blended products.

As used herein, the phrases “blending process,” “blending program,” and the like are used interchangeably unless context suggest otherwise or warrants a particular distinction among such terms. A blending process may comprise a series or sequence of blender settings and operations to be carried out by the blending device. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

Disclosed herein is a blending system, including a blending container for use with an immersion blender. The blending container may include curved or domed bottom surface that extends into a cavity of the container and that is configured to engage with the bell of the immersion blender. The blending container may prevent one or more of: splashing of foodstuff during the blending process, suction of the immersion blender to a bottom of the container during use, or cavitation of the foodstuff. The containers may direct foodstuff within the container or towards the immersion blender to prevent splashing and facilitate mixing of foodstuff. The blending container may further include an annular shoulder that tapers inwardly from a sidewall of the container to an open end.

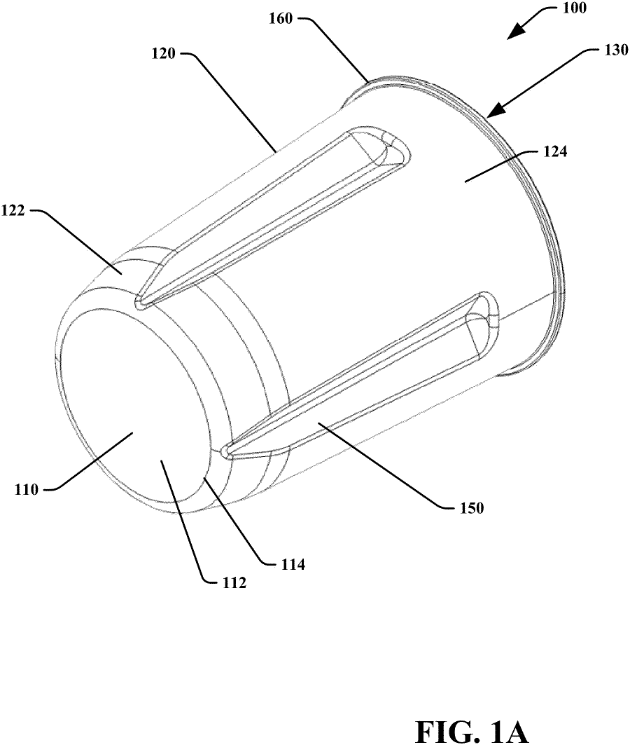

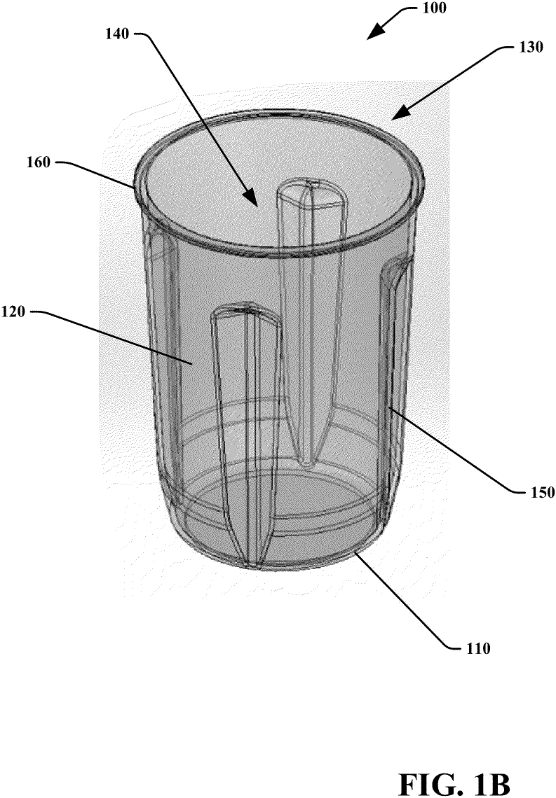

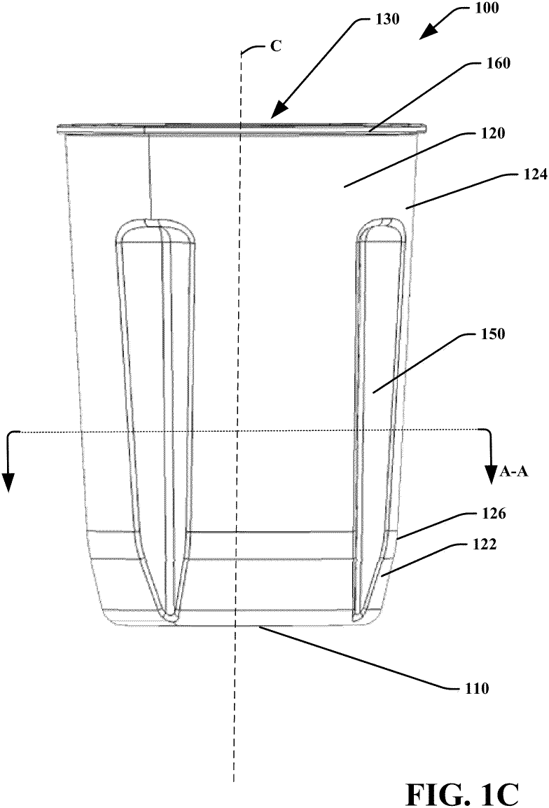

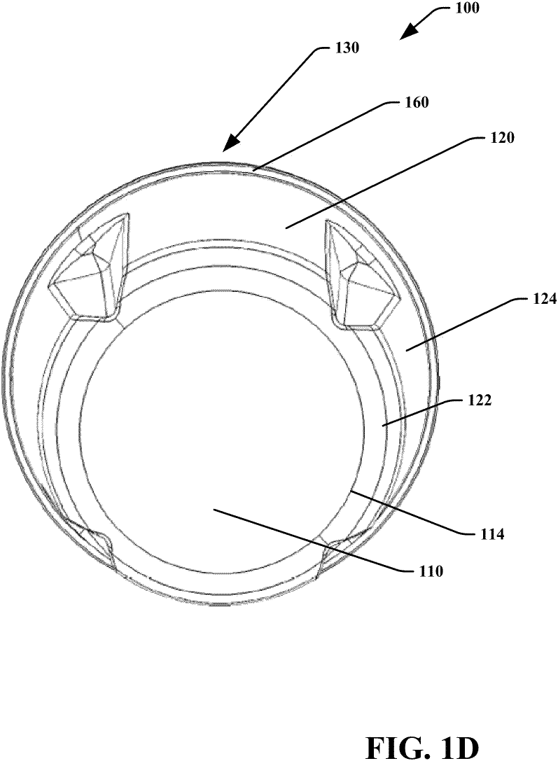

Referring now to FIGS. 1A-D, shown is a blending container 100 in accordance with various disclosed embodiments. The blending container 100 may generally comprise a closed end 110, at least one or a plurality of sidewalls 120, and an open end 130. The closed end or base 110 may include a bottom surface 112 and a periphery 114. As described herein, the bottom surface 112, or portion thereof, may be curved, domed, concave, or the like, toward or extending into the blending container 100. The sidewall 120 may generally circumscribe the periphery 114 of the closed end 110 and extend upward therefrom to define a cavity 140. The curved, domed, concaved, or similar bottom surface 112 may extend into the cavity 140. The cavity 140 may be accessible or open through the open end 130. The open end 130 and cavity 140 may be configured to receive foodstuff and at least a portion of the immersion blender to facilitate blending of the foodstuff therein.

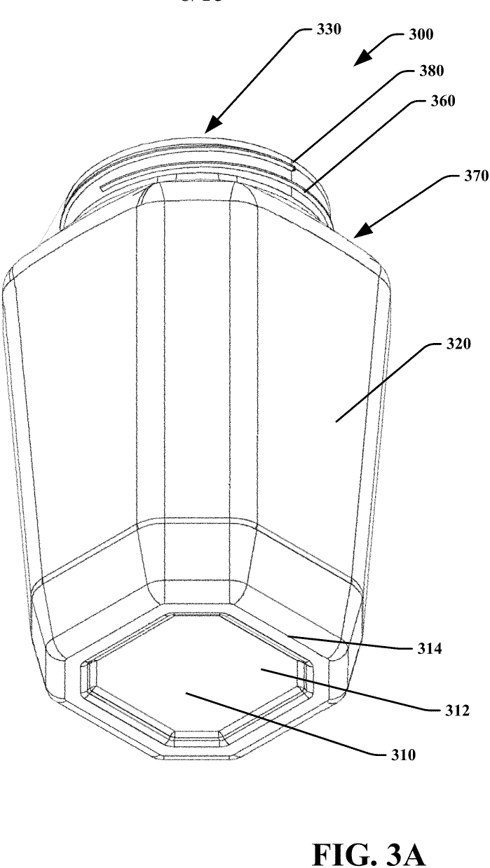

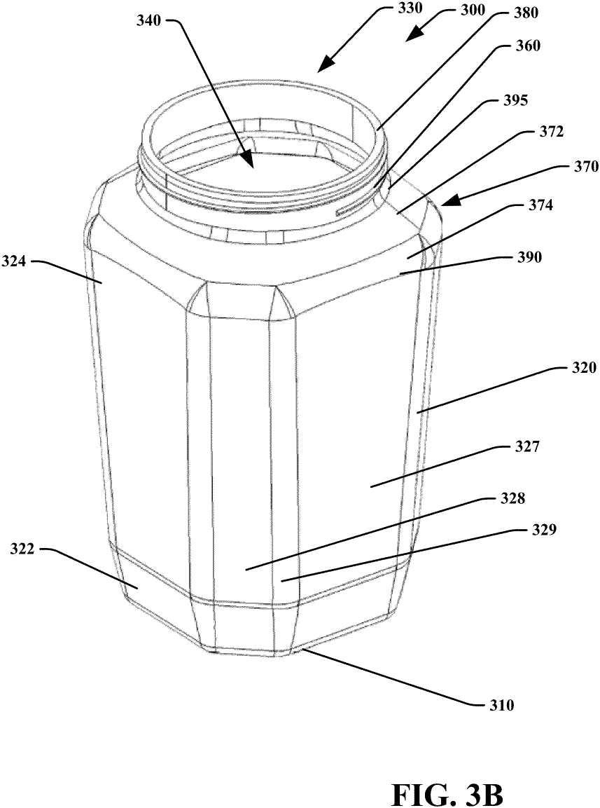

In an embodiment, the blending container 100 may be generally cylindrical, conical, or frustoconical, the closed end or open end generally circular (e.g. having a general circumference), and the sidewall(s) generally curved or round. It is also noted, however, that the blending container 100 may generally comprise any size and shape as desired, including round, square, rectangular, irregular, or the like. Additionally, the blending container 100 may comprise multiple shapes, for example the closed end or open end generally circular while the sidewall(s) are squared. It is noted that terms such as circumference, diameter, etc., while including round, circular, and cylindrical shapes, may also refer to the periphery or general aspects of a non-circular or round shape, such as a squared shape. For example, FIGS. 3A-B show a blending container comprising a squared, n-sided prism (where n is a number from 2-8 or more), or not perfectly circular, sidewall or blending container shape.

Further, unless context suggest otherwise, descriptions of shapes (e.g., circular, rectangular, squared, triangular, etc.) and the nature of the shapes (e.g., straight, curved, rounded, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc. Additionally, as used herein, the word near may be used to describe an aspect that is directly adjacent to or at another aspect, relatively close to another aspect, that is within 1-3 cm.

Moreover, a sidewall may have any number of sides, such as 1, 2, 3, 4, 5, 6, 7, 8, 9, 10, etc. sides, and may generally adopt the shape of a parallelogram, circle, rectangle, square, portion of any of the foregoing, or the like. As described herein, the sidewall(s) may include any number of flutes, such as flutes 150, 250. A sidewall or sidewalls, although encompassing a cavity therein, may also be referred to in a singular form or a plural form. Edges and corners of sidewall(s), or portions connecting sidewall(s), may similarly have any number of sides, such as 1, 2, 3, 4, 5, 6, 7, 8, 9, 10, etc. sides, and may generally adopt the shape of a parallelogram, circle, rectangle, square, portion of any of the foregoing, or the like. Although general measurements or indications of height, length, width, distance, thickness, and angles may be disclosed, it is noted that these aspects are broadly defined within this disclosure unless specifically indicated for a particular embodiment.

As shown in FIGS. 1A-D, the sidewall 120 may taper or flare inwardly or outwardly long a length of the sidewall 120, including as the sidewall extends from the closed end 110, as the sidewall 120 extends toward and form the open end 130, or at any point or portion long the sidewall 120. FIG. 1C for example, shows a taper or flare 122 inwardly as the sidewall 120 extends toward the closed end 110 and a taper or flare 124 outwardly as the sidewall 120 extends toward and form the open end 130. It is noted that the blending container 100 may include embodiments where only a base portion of the sidewall 120 tapers inwardly as it extends to the closed end 110 or where only a top portion of the sidewall 120 tapers outwardly as it extends to the open end 130. The tapering or flare of the sidewall 120 may generally be from 1 to 70 degrees in reference to the connection or connection point of the sidewall 120 to the closed end 110 or open end 130. The tapering or flare of the sidewall 120 may also or alternatively generally be from 1 to 70 degrees in reference to a middle or planar portion of the sidewall 120. Although specific dimensions and angles are included, these are exemplary and are not intended to be limiting. The dimensions can be any appropriate dimension to account for a particularly sized immersion blender, blending process or amount to be blended.

It is further noted that the taper or flare 122, 124 may be similar in gradient or angle, may be different in gradient or angle, may be inverted, and the like. It is noted that gradient may refer to the “steepness” of the taper or flare, or the change in the angle of the taper or flare as compared to the length of the taper or flare. For example, as in FIG. 1C, the tapered portion 122 of the sidewall 120 that extends inwardly toward the closed end 110 may begin at a certain point or area 126 of the sidewall 120 and may have a greater gradient or angle than the gradient or angle at which the sidewall 120 flares 124 as the sidewall 120 extends to the open end 130. In an embodiment, the point or area 126 of the sidewall 120 where the sidewall tapers 122 inwardly toward the closed end 110 may be the same point or area 126 of the sidewall 120 where the sidewall flares 124 outwardly toward the open end 130. The sidewall 120 may also include an area between the points of tapering or flaring that is generally the same angle or gradient, i.e., without taper or flare.

In an embodiment, the blending container 100 may be generally conical. For instance, the sidewall 120 may have various circumferences along a length of the sidewall 120, where a minimum circumference of the sidewall 120 is where the sidewall 120 meets, connects, or is adjacent to the closed end 120 or bottom surface 112 and where a maximum circumference of the sidewall 120 is where the sidewall 120 is adjacent to, meets, or forms the open end 130. An example of a conical shape of the blending container 100 is shown in FIG. 1D. More generally, the sidewall 120 may have a first circumference near or at the closed end 110 and a second circumference near or at the open end 130, wherein the first circumference is different than the second circumference. In an embodiment, the first circumference of the sidewall 120 near the closed end 100 is smaller than the second circumference of the sidewall 120 near the open end 110. In an embodiment, the first circumference of the sidewall 120 near the closed end 100 may be greater than the second circumference of the sidewall 120 near the open end 11 (e.g. reverse draft).

The gradient of the sidewall 120, e.g. the change in angle of the sidewall 120 as the sidewall 120 extends from the closed end 110 to the open end 130 (or vice versa) may be consistent or uniform along the entirety of the sidewall 120, or the gradient may vary, where certain areas of the sidewall 120 may change in circumference to larger extents or to smaller extents comparatively. (See for example area 122 versus area 124, where area 122 may have a steeper gradient or greater change in circumference compared to adjacent circumferences). In an embodiment, the blending container 100 and sidewall 120 may have many circumferences, one that is the same or almost the same as the periphery 114 of the closed end 110, one that is the same or almost the same as the periphery of the open end 130, and some larger and/or some smaller circumferences therebetween. In an embodiment, almost the same may mean having a circumference within 5 cm, within 3 cm, or within 2 cm of the circumference of the periphery of the open 130 or closed ends 110.

Although embodiments of the blending container 100 may generally describe a smaller circumference at the closed end 110 and a larger circumference at the open end 130, it is noted that the reverse is also contemplated and disclosed herein. Additionally, the circumferences of the sidewall may fall within or be the same as the minimum and maximum circumferences of the closed end or open end (noting that the closed end may serve as either the minimum or maximum circumference and vice versa regarding the open end), or the circumferences of the sidewall may be greater or smaller than both the circumferences of the open end and closed end.

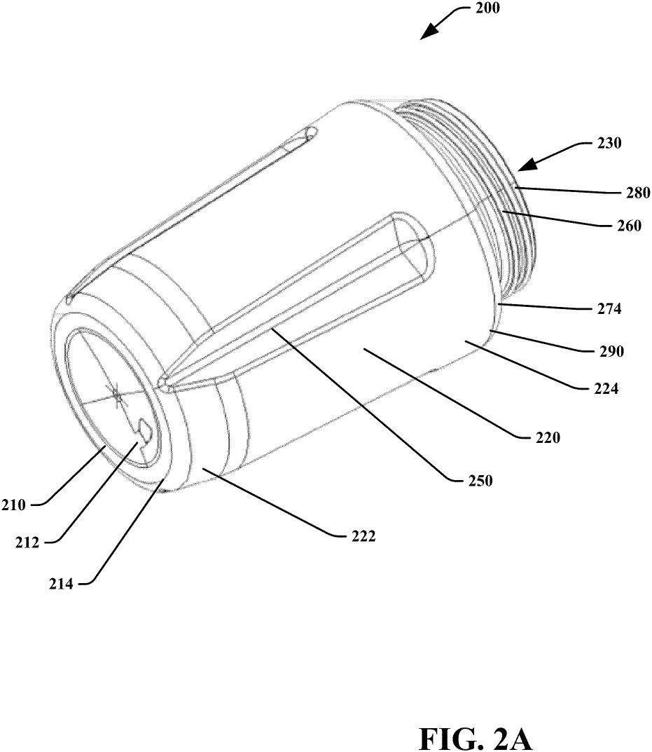

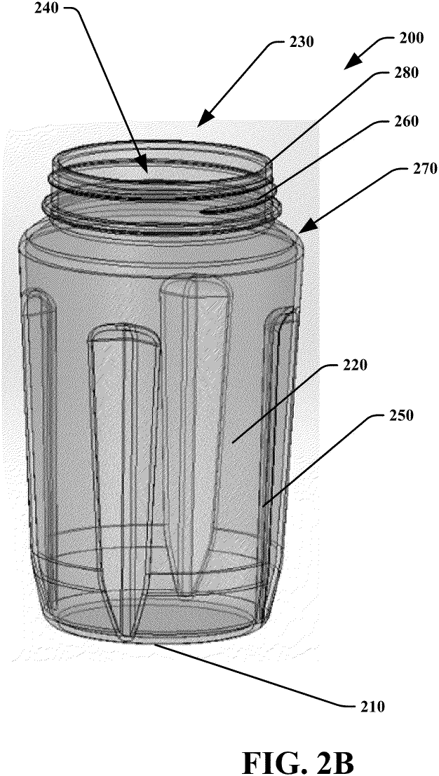

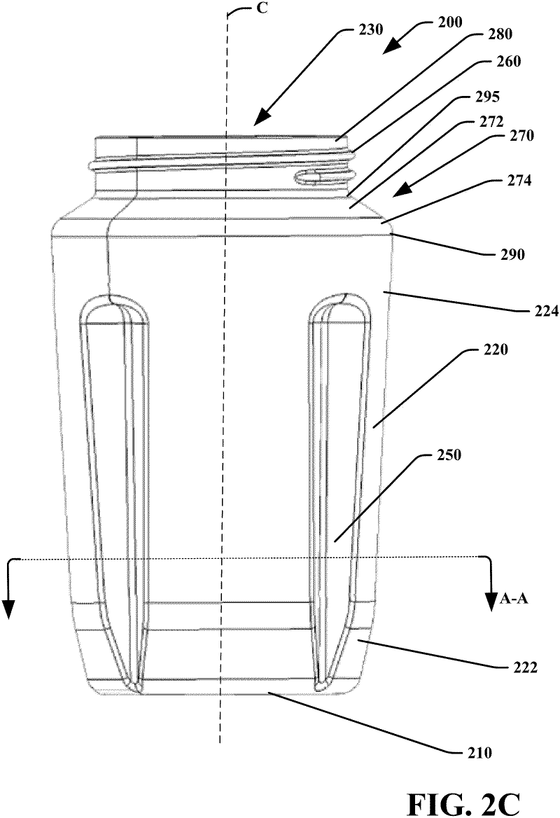

In an embodiment, the blending container 100 may further comprise a lip 160 at the open end 130. The lip 160 may protrude from the sidewall 120 or the sidewall 120 may protrude at the open end 130 to form a lip 160. The lip 160 may generally circumscribe the open end 130. In an embodiment and as shown in FIGS. 1A-D, the lip 160 may be continuous along the circumference of the open end 130 or sidewall 120. In an embodiment, the lip 160 may be discontinuous or include certain cutouts, patterning, or the like. In FIGS. 1A-D, the lip 160 is generally shown as a rounded edge of the sidewall 120 that protrudes from the adjacent area of the sidewall 120 and abuts the open end 130 of the blending container 100. It is noted that the lip 160, may not be rounded, and instead may be tapered, angled, threaded, or the like. The lip 160 may also include engagement elements thereon, such as patterning or the like. In an embodiment, the lip 160 is sized and shaped to selectively engage with a lid. The lip 160 and lid may engage by friction fit, snap fit, pressure fit, or secured by and engagement mechanism such as being threaded (as shown in FIGS. 2A-C for example).

Turning to FIGS. 2A-C, shown is blending container 200. Blending container 200 may be similar to blending container 100, including having a closed end 210, at least one or a plurality of sidewalls 220, and an open end 230. The closed end or base 210, similar to blending container 100, may include a bottom surface 212 and a periphery 214. As described herein, the bottom surface 212, or portion thereof, may be curved, domed, concave, or the like toward or extending into the blending container 200. The sidewall 220 may generally circumscribe the periphery 214 of the closed end 210 and extend upward therefrom to define a cavity 240. The curved, domed, concaved, or similar bottom surface 212 may extend into the cavity 240. The cavity 240 may be accessible or open through the open end 230. The open end 230 and cavity 240 may be configured to receive foodstuff and at least a portion of the immersion blender to facilitate blending of the foodstuff therein.

The sidewall 220 of blending container 200 may also be similar to the sidewall 120 of blending container 100 and may have the various circumferences as previously described. For example, sidewall 220 may have various circumferences along a length of the sidewall 120, may have a generally conical shape, may have a minimum or smaller circumference at or near the closed end 210 or bottom surface 212, may taper inwardly towards the closed end 210 or bottom surface 212 (see 222), may flare outwardly towards the open end 210 (see 224), vice versa, etc. All previous description related to the circumferences and shape of the blending container 100 is also relevant and transferable to blending container 200, except that the circumference described in relation to the open end 130 of the blending container 100 may be considered the same or similar as the circumference of the sidewall 220 abutting, adjacent, near, or just before the annular shoulder (such as circumference 290). In an embodiment, similar may mean the circumference of the open end 130 of the blending container 100 is within 5 cm, within 3 cm, or within 2 cm of the circumference of the sidewall 220 abutting, adjacent, near, or just before the annular shoulder (such as circumference 290). Blending container 200, in some embodiments, may be viewed as blending container 100 having an annular shoulder and annular rib in place of or on top of the open end 130.

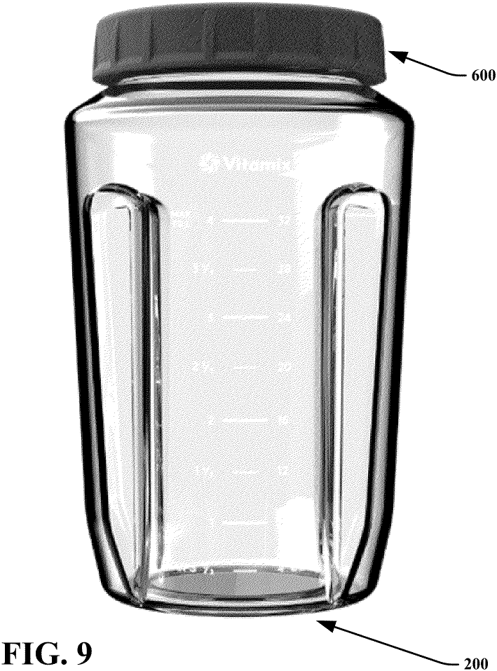

To this end, blending container 200 may further include an annular shoulder 270. The annular shoulder 270 may taper inwardly from a top of the sidewall 220 to an annular rib 280. The annular rib 280 may extend from the annular shoulder 270 and form the open end 230 of the blending container 200. The annular rib 280 may, in an embodiment, have generally the same circumference or shape along its length. In an embodiment, generally the same circumference may include within 3 cm or within 2 cm (not including any engagement features or the threads that may extend from the annular rib as herein described). Alternatively, the annular rib 280 may also taper or flare as desired. The annular rib 280 may include an engagement feature 260. The engagement feature 260 may serve to selectively engage with or connect to a lid, such as lid 600, for example. The lid 600 may include a continuous surface, so that when connected to the engagement feature 260 of the blending container 200, the lid 600 covers the open end 260 and contains the foodstuff (blended or unblended) therein. In an embodiment, the annular rib 280 may also be threaded, as shown in FIGS. 2A-C. In an embodiment, the annular rib 280 may include a lip, such as lip 160 described regarding blending container 100. In an embodiment, the annular rib 280 is sized and shaped to selectively engage with a lid having a corresponding configuration. The engagement feature or the annular rib 280 and lid may engage by friction fit, snap fit, pressure fit, or secured by and engagement mechanism such as being threaded. The threading may be sized and shaped to mate with and selectively engage with a corresponding lid as herein described. FIG. 9 shows an embodiment of blending container 200 selectively engaged with lid 600, for example.

In an embodiment, the sidewall 230 just before, near, connecting to, or at the annular shoulder 280 may have a first circumference 290. The annular rib 280 connecting to the annular shoulder 270 may have a second circumference 295. In an embodiment, the first circumference 290 of the sidewall 230 may be larger than the second circumference 295 of the annular rib, and the annular shoulder 270 may taper inwardly between these two circumferences 290, 295. In an embodiment, the first circumference 290 of the sidewall 230 may be up to 15 cm larger, 10 cm larger, 5 cm larger or 1 cm larger than or the same as the second circumference 295 of the annular rib and every dimension therebetween.

The annular shoulder 270 may include a tapered portion 272 and a curved portion 274. In an embodiment, the curved portion 274 may connect the sidewall 220 to the tapered portion 272. In an embodiment, the tapered portion 272 may connect the curved portion 274 to the annular rib 280. The curved portion 274 may have a circumference that is the same, slightly larger, slightly smaller, or one or more of the foregoing compared to the circumference 290 of the sidewall 230. In an example, the curved portion 274 may initially have the same circumference as the circumference 290 of the sidewall 230 and then may begin to taper inwardly into the tapered portion 272 of the annular shoulder 270. In an embodiment, the difference between a first circumference of the curved portion 274 at the sidewall 230 and a second circumference of the curved portion 274 at the tapered portion 272 of the annular shoulder 270 may be under 5 cm.

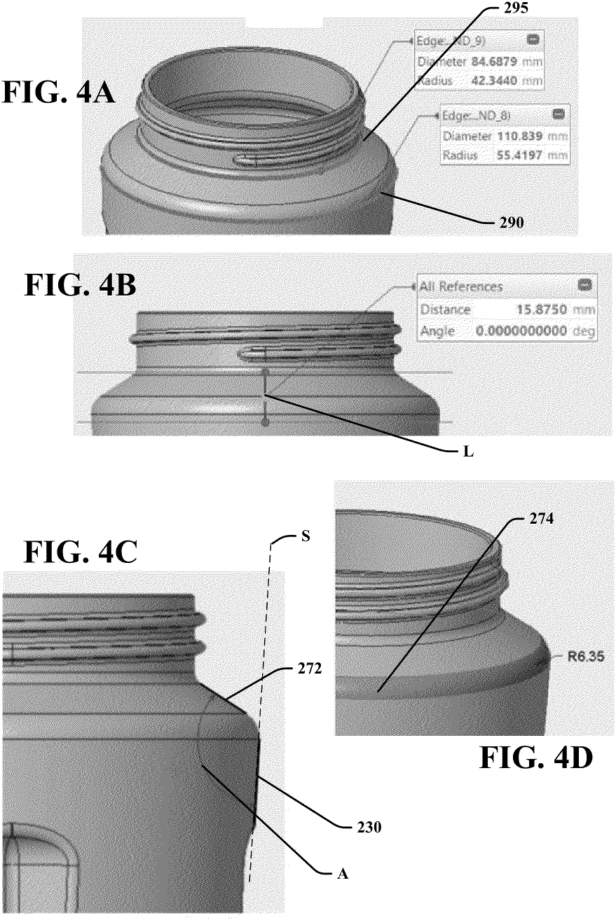

Turning to FIGS. 4A-D, shown is an embodiment of the blending container 200 having an annular shoulder 270. As shown, the tapered portion 272 of the annular shoulder 270 and the sidewall 230 may be positioned at an angle A from one another. In an embodiment, the angle A between the tapered portion 272 of the annular shoulder 270 and the sidewall 230 may be from about 110-130 degrees as measured from an axis defined by the sidewall (shown as S). In an embodiment, the angle A between the tapered portion 272 of the annular shoulder 270 and the sidewall 230 may be about 120 degrees as measured from an axis defined by the sidewall (shown as S). This angle A, and the smaller circumference of the sidewall 220 compared to the open end 230 or annular rib 280, may better contain foodstuff within the blending container 200 as it is blended with an immersion blender 700, while still maintaining adequate access and maneuvering of the immersion blender 700 into the blending container 200 through the open end 230. This angle A, and the smaller circumference of the sidewall 220 compared to the open end 230 or annular rib 280, may allow for a sidewall 220 having an adequate circumference and desired shape, such as tapering or flaring of the sidewall 220, to insert and maneuver the immersion blender 700 and to prevent cavitation or facilitate adequate or desired mixing of foodstuff by the immersion blender 700.

As further shown, the tapered portion 272 of the annular shoulder 270 and the curved portion 274 of the annular shoulder 270 may together have a length L. In an embodiment, the length L of the tapered portion 272 of the annular shoulder 270 and the curved portion 274 of the annular shoulder 270 may be from about 10-20 mm. In an embodiment, the length L of the tapered portion 272 of the annular shoulder 270 and the curved portion 274 of the annular shoulder 270 may be about 16 mm. This length L, and the smaller circumference of the sidewall 220 compared to the open end 230 or annular rib 280, may better contain foodstuff within the blending container 200 as it is blended with an immersion blender 700, while still maintaining adequate access and maneuvering of the immersion blender 700 into the blending container 200 through the open end 230. This length L, and the smaller circumference of the sidewall 220 compared to the open end 230 or annular rib 280, may allow for a sidewall 220 having an adequate circumference and desired shape, such as tapering or flaring of the sidewall 220, to insert and maneuver the immersion blender 700 and to prevent cavitation or facilitate adequate or desired mixing of foodstuff by the immersion blender 700.

Turning to FIGS. 3A-B, shown is blending container 300. Blending container 300 may be similar to blending containers 100, 200 including having a closed end 310, at least one or a plurality of sidewalls 320, and an open end 330. The closed end or base 310, similar to blending containers 100, 200 may include a bottom surface 312 and a periphery 314. As described herein, the bottom surface 312, or portion thereof, may be curved, domed, concave, or the like toward or extending into the blending container 300. The sidewall 320 may generally circumscribe the periphery 314 of the closed end 310 and extend upward therefrom to define a cavity 340. The curved, domed, concaved, or similar bottom surface 312 may extend into the cavity 340. The cavity 340 may be accessible or open through the open end 330. The open end 330 and cavity 340 may be configured to receive foodstuff and at least a portion of the immersion blender to facilitate blending of the foodstuff therein.

The sidewall 320 of blending container 300 may also be similar to the sidewalls 120, 220 of blending containers 100, 200 and may have the various circumferences as previously described. For example, sidewall 320 may have various circumferences along a length of the sidewall 320, may have a generally conical shape, may have a minimum or smaller circumference at or near the closed end 310 or bottom surface 312, may taper inwardly towards the closed end 310 or bottom surface 312 (see 322), may flare outwardly towards the open end 310 (see 324), vice versa, etc. All previous description related to the circumferences and shape of the blending container 100 is also relevant and transferable to blending container 300, except that, like blending container 200, the circumference described in relation to the open end 130 of the blending container 100 may be considered the same or similar as the circumference of the sidewall 220, 320 abutting, adjacent, near, or just before the annular shoulder (such as circumference 290, 390). Blending container 300, in some embodiments, like blending container 200, may be viewed as blending container 100 having an annular shoulder and annular rib in place of or on top of the open end 130, and instead forming open end 330 with access to cavity 340.

To this end, blending container 300 may further include an annular shoulder 370 that is the same or similar to annular shoulder 270 of blending container 200. For example, the annular shoulder 370 may taper inwardly from a top of the sidewall 320 to an annular rib 380 and may include a curved portion 374 and a tapered portion 272. All previous description related to the circumferences and shape of the blending container 200 is also relevant and transferable to blending container 300.

Blending container 300 may differ from blending container 200 in that blending container 300 may include a generally square body as seen in FIGS. 3A-B. For example, blending container 300 may include one or more generally planar sidewalls 327. In an embodiment, blending container 300 may include four generally planar sidewalls 327. The one or more generally planar sidewalls 327 may be connected to one another at a corner. In an embodiment, the corner may be rounded. In an embodiment, the corner may be straight-edged. In an embodiment, the corner may include one or more sidewalls that form a rounded corner. For example, each corner in FIGS. 3A-3B showing an embodiment of blending container 300 may include a middle corner sidewall 328 and two adjacent tapered sidewalls 329, wherein the tapered sidewalls 329 connect each corner sidewall 328 to the generally planar sidewalls 327 on each side.

Regarding blending containers 200, 300, which in an embodiment, may include a smaller opening 230, 330 that widens by an annular shoulder 270, 370 to the sidewall 230, 330, (in other words, where the open end 230, 330 has a smaller diameter than the sidewall 230, 330 or annular shoulder 270, 370), this shape (which also may be referred to as a bell shape) may allow for a reduction of or prevent splashing or spillage of foodstuff during the blending process. Additionally, the distance from or length of the annular rib 260, 360 that forms the open end 230, 330, may help break the momentum of any liquid of foodstuff traveling up the blending container 200, 300 side during the blending process and prevent the foodstuff from coming out the top of the open end 230, 330.

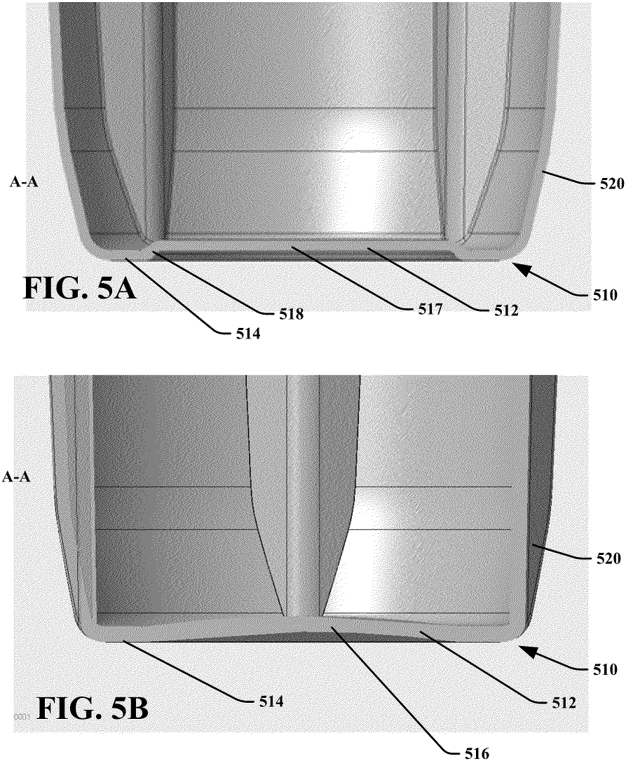

Turning to FIGS. 5-9, shown are additional aspects which may be incorporated into any of the blending containers 100, 200, 300 herein described, including flutes 150, 250, a curved bottom 500, and a cap 600.

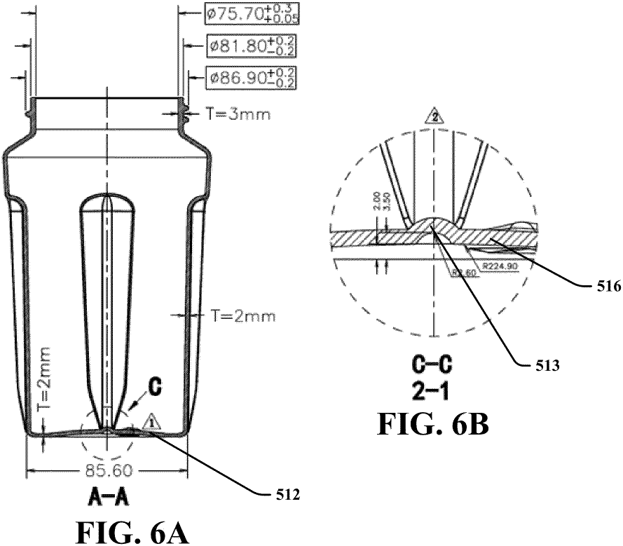

FIG. 5A shows a closed end 510 of a blending container, which can be any of 100, 200, 300, having a recessed 517 and stepped in 518 bottom surface 512. FIG. 5B and FIGS. 6A-B show a closed end 510 of a blending container, which can be any of 100, 200, 300 having a curved 516 bottom surface 512 (noting that the curved 516 bottom surface 512 in FIGS. 6 A-B further include an apex 513 having an additional protrusion). FIGS. 5A-B and 6 A-B are cross-sectional views taken along line A-A shown in FIG. 1C for blending container 100 and FIG. 2C for blending container 200. Although not explicitly shown, the same cross-section can be taken from blending container 300 and can include any of these shaped bottom surfaces as described. All of blending containers 100, 200, 300 may include any of, or a combination of, the different shaped bottom surfaces 512 shown in FIGS. 5 A-B and 6 A-B having a recessed 517 and stepped 518 bottom surface 512 (FIG. 5A), having a curved or domed 516 bottom surface 512 (FIG. 5B), or having a curved or domed 516 bottom surface having an additional protrusion at the apex 513 (FIGS. 6A-B). It is also noted that the bottom surface 512 may be generally planar, such as bottom surface 112 shown in FIG. 1D. Generally planar may include a flat surface having a variation of less than 1 cm.

As described herein, the closed end 110, 210, 310 of blending containers 100, 200, 300 may include a bottom surface 112, 212, 312 and a periphery 114, 214, 314. These may have the same shape as shown in FIGS. 5A or 5B including a bottom surface 512 and periphery 514. The recess 517 of the bottom surface 512 may be such that the bottom surface 512 extends into the cavity of the blending container, and may include a step 518 into the cavity and a recess 517 that is generally planar. Generally planar may include a flat surface having a variation of less than 1 cm. The curve 516 of the bottom surface 512 may be concave such that the bottom surface 512 extends into the cavity of the blending container in a domed or curved manner. The curved 516 bottom surface 512 may be configured to direct foodstuff toward a middle of the blending container, away from the sidewall(s) of the container, or toward a blade 715 of the immersion blender 700 when an immersion blender 700 is inserted into the container 100, 200, 300.

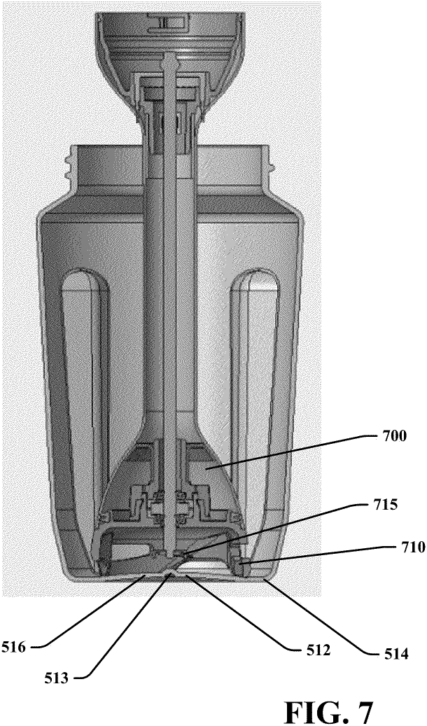

The bottom surface 512 may have an apex 513 that is generally in the middle of the curved portion 516. It is noted that the curved bottom surface 512 and curved portion 516 of the bottom surface 512 may generally be interchangeable and refer to the bottom surface, or portion thereof, that is curved. The bottom surface 512 may have an apex 513 that is generally in the middle of the curved portion 516 and in the middle of the bottom surface 512. It is noted that the apex 153 may be offset from a general center. In an embodiment, the apex 513 may further include an additional protrusion that extends beyond the curved portion, as shown in FIGS. 6B and 7. This additional protrusion may be round. The dome or curve of the bottom surface 512 may be generally semi-spherical but other shapes, such as semi-polyhedrons, irregular convex shapes, geodesic spheres, or other shapes which direct flow of material can be utilized. The dome or curve of the bottom surface 512 may further include one or more slight indents to assist in a blow-molding process when the blending containers are blow-molded as described herein.

The bottom surface 512, and curvature 516 or recess 517 thereof, may begin and extend from the periphery 514 of the closed end 510 to the apex 513, where the periphery 514 of the closed end 510 itself may remain relatively flat or not curved. In an embodiment, although the bottom surface 512 may extend into the cavity in a recessed or curved manner, the periphery 514 may remain flat and provide a surface on which the blending container 100, 200, 300 may be able to independently stand up. Generally flat may include a flat surface (or portion thereof) having a variation of less than 1 cm form its highest point to its lowest point. The closed end 510 of the blending container, including the curved bottom surface 512 and periphery 514 may include contact points configured to engage a bell 710 of an immersion blender 700, see FIG. 7. The periphery 514 of the closed end 510 being relatively flat or not curved may serve as contact points configured to engage the bell 710 of the immersion blender 700, see FIG. 7. The curved bottom surface 512 abutting the periphery 514 of the closed end 510 may serve as contact points configured to engage a bell 710 of the immersion blender 700, see FIG. 7.

In an embodiment, the curved bottom surface 512 may be configured to allow the bell 710 of the immersion blender 700 to rotate on the curved portion in a ball and socket like manner when the immersion blender is moved in a stirring motion. The stirring motion and curved bottom surface 512 allows a blade 715 of the immersion blender 700 to maintain a distance from the bottom surface of the blending container, while also allowing flow of material to pass into the blades 715. In an embodiment, the distance between the blades 715 of the immersion blender 700 and the curved bottom surface 512 may be between 1 and 10 cm. It is noted that the bell 710 of an immersion blender 700 may generally refer to the housing or shell that surrounds at least a portion of the blade 715 of the immersion blender 700.

In an embodiment, the bell 710 of the immersion blender 700 can have a terminal diameter that is different in size relative to the diameter of the curve or dome on the bottom 512 of the blending container. In an embodiment, the terminal diameter, and difference between the terminal diameter of the bell 710 and diameter of the curve or dome on the bottom 512 of the blending container may also serve to provide the distance between the blades 715 of the immersion blender 700 and the curved bottom surface 512. In an embodiment, the difference between the terminal diameter of the bell 710 and diameter of the curve or dome on the bottom 512 of the blending container may be between 1 and 20 cm. In an embodiment, the curve or dome on the bottom 512 of the blending container may be generally wide enough (e.g., not narrow) such to prevent the blades 715 of the immersion blender 700 from contacting the bottom 512 of the blending container.

Blending containers 100, 200, 300, may further include at least one flute 150, 250. Although flutes are not explicitly shown in FIGS. 3A-B showing a squared blending container 300, it is noted that one or more flutes may be incorporated into this blending container 300 in the same way they are for blending containers 100, 200. Blending containers 100, 200, 300 may include any number of flutes, including 1, 2, 3, 4, 5, 6, 7, 8, 9, 10, etc. flutes. For example, FIGS. 1-2 show blending container 100, 200 including flutes 150, 250. The blending containers 100, 200 show four flutes in each blending container 100, 200. The flutes 150, 250 may be elongated and extend along a length of the sidewall 130, 230 in a vertical manner. In an embodiment, the at least one flute 150, 250 extends from a point at or near the closed end 110, 210 toward the open end 130, 230 of the blending container 100, 200 or toward a point at or near the open end 130, 230 of the blending container 100, 200. In an embodiment, the flutes 250, 250 may extend from a point within 5 cm of the closed end 110, 210. In an embodiment, the flutes 150, 250 may extend toward a point that is 10 cm or less from the open end 130, 230. In an embodiment, the flutes 150, 250 may extend toward a point that is 10 cm or more from the open end 130, 230.

In an embodiment, the height of the at least one flute 150, 250 on the sidewall 120, 220 may indicate a suggested maximum or predetermined capacity of the blending container 100, 200 for foodstuff. In an embodiment, the at least one flute 150, 250 may extend from a point at or near the closed end 110, 210 about ⅔ up the length of the sidewall 120, 220 of the blending container 100, 200. It is also noted that the flutes 150, 250 may extend any other length including from ½ to at or near the open end 130, 230 of the blending container 100, 200. The flutes may also extend from the open end 130, 230 of the blending container 100, 200 to any other length towards the closed end 110, 210.

In an embodiment, the flutes 150, 150 may include a depression or may otherwise curve inwards from the sidewall 120, 220 of the blending container 100, 200 to a central axis C of the blending container 100, 200 as shown in FIGS. 1C and 2C. The flutes 150, 250 may have a triangular or pointed shape into the cavity 140, 240 of the blending containers 100, 200, or the flutes 150, 250 may be curved. The flutes 150, 250 may also include any other shape or patterning, including but not limited to, an irregular shape or a patterned interior surface. The flutes 150, 250 may be configured to direct foodstuff toward a middle of the blending container, away from the sidewall(s) of the container, or toward a blade 715 of the immersion blender 700 when an immersion blender 700 is inserted into the container 100, 200, 300. In an embodiment, the flutes 150, 250 may be wider at one end of the flute and narrower at the other end of the flute. For example, the flute 150, 250 may be wider at the end of the flute 150, 250 toward the open end 130, 230 of the blending container 100, 200 and may be narrower at the end of the flute 150, 250 toward the closed end 110, 210 of the blending container 100, 200. It is noted that the reverse may also be true.

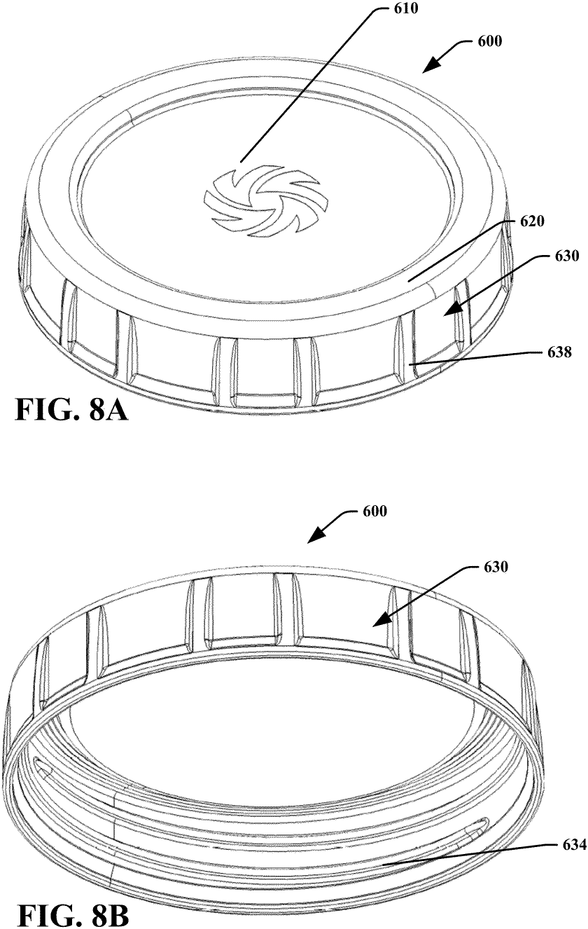

Turning to FIGS. 8A-B, shown is a cap 600. The cap may be selectively engageable with the engagement features 160, 260, 360 of the blending containers 100, 200, 300, such as the lip shown in FIGS. 1A-D and the threaded annular rib shown in FIGS. 2-3. The cap 600 may include a planar top surface 610 and a periphery 620. The periphery 620, in an embodiment, may be slightly raised from the planar top surface 610. The periphery 620, in an embodiment, may be continuous with the planar top surface 610. The cap 600 may further include a flared wall 230 that extends from periphery 620 and away from the planar top surface 610. An interior of the flared wall 630 may include an engagement feature 634 that is selectively engageable or configured to mate with the engagement features 160, 260, 360 of the blending containers 100, 200, 300, such as the lip shown in FIGS. 1A-D and the threaded annular rib shown in FIGS. 2-3. As shown in FIG. 8B, the engagement feature 634 may be threaded. In an embodiment, the flared wall 630 may further include ribbing or patterning 638 on an exterior of the flared wall 630 to facilitate grasping, twisting, and removal of the cap 600 from the blending container 100, 200, 300. FIG. 9 shows cap 600 as selectively engaged with blending container 200.

The immersion blender 700 may generally comprise a motor body, an arm that includes an axial shaft, a cutting instrument at an end of the axial shaft wherein the axial shaft transfers power from the motor body to the cutting instrument, and a bell 710 generally surrounding the cutting instrument. An immersion blender system may further include a blending container 100, 200, 300 that includes a dome shaped section on the bottom surface 512 or closed end 510 of the container 100, 200, 300 and flutes 150, 250 that extend from proximal the closed end 110, 210, 310 of the blending container 100, 200300, wherein the dome shaped end 512 and the bell 710 of the immersion blender 710 may be constructed to act in a ball and socket arrangement when the bell 710 is in contact with the bottom surface 512 of the blending container 100, 200, 300.

In an embodiment, the blending containers 100, 200, 300 may be blow-molded. In an embodiment, the blending containers 100, 200, 300 may be blow-molded triton. Blow-molding of the blending containers 100, 200, 300 may allow the blending container to have a bell shape, or a shape where the container initially widens and then narrows into a smaller opening (i.e., an annular shoulder). The annular shoulder may allow for a reduction in or prevent splashing of foodstuff during the blending process. The blending containers 100, 200, 300 may also be injection-molded, etc., and may include any desirable plastic or material as may be used in the art.

Additionally, it is noted that the holding capacity for the blending containers 100, 200, 300 disclosed herein may vary and may include any about from 4 oz. to 60 oz., for example. The blending containers 100, 200, 300 may be single serving, such as 8 oz. or may be single serving, but sized larger (such as for water bottles), including up to (or over) 128 oz. The blending containers 100, 200, 300 may be 32 oz., 40 oz., 48, oz. etc. The blending containers 100, 200, 300 may be used in commercial applications and may include larger holding capacities not explicitly listed.

The blending containers 100, 200, 300 may be used with any existing immersion blenders and with existing immersion blenders having a bell shape.

Blending containers 100, 200, 300, annular shoulder, curved bottom surface, and/or flutes may generally improve the blending process with an immersion blender and may prevent one or more of: splashing of foodstuff during the blending process, suction of the immersion blender to a bottom of the containers during use, or cavitation of the foodstuff. Blending containers 100, 200, 300, annular shoulder, curved bottom surface, and/or flutes may direct foodstuff within the container or towards the blade assembly to prevent splashing and facilitate mixing of foodstuff, as well as increase ease of use without relying on the user to constantly adjust and move the immersion blender up and down within the container during blending.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A blending container configured for use with an immersion blender, the blending container comprising:
a closed end;
at least one sidewall that extends from a periphery of the closed end, wherein the closed end and at least one sidewall form a cavity; and
an open end opposite the closed end, wherein the open end is configured to receive foodstuff and at least a portion of the immersion blender;
wherein the at least one sidewall further comprises at least one flute extending from a first point at or near the closed end towards the open end of the blending container;
wherein the closed end includes a concaved portion that extends from a periphery of the closed end into the cavity of the blending container.

2. The blending container of claim 1, wherein the at least one sidewall has a first circumference near the closed end and a second circumference near the open end, wherein the first circumference is different than the second circumference.

3. The blending container of claim 2, wherein the first circumference of the at least one sidewall near the closed end is smaller than the second circumference of the at least one sidewall near the open end.

4. The blending container of claim 1, wherein the at least one sidewall tapers inwardly toward the closed end of the blending container from a shoulder of the at least one sidewall.

5. The blending container of claim 1, wherein the at least one sidewall tapers outwardly toward the open end of the blending container from the closed end.

6. The blending container of claim 1, wherein the at least one flute extends toward a second point on the at least one sidewall that indicates a predetermined capacity of the blending container.

7. The blending container of claim 1, wherein the at least one flute includes a depression that extends from a periphery of the at least one sidewall toward a center axis of the blending container.

8. The blending container of claim 1 further comprising a protruding lip at the open end of the blending container that is configured to engage with a lid.

9. The blending container of claim 1, wherein the concaved portion of the closed end is configured to direct foodstuff toward a blade of the immersion blender.

10. The blending container of claim 1, wherein the concaved portion includes contact points configured to engage a bell of the immersion blender and the concaved portion is configured to allow the bell of the immersion blender to rotate on the concaved portion in a ball and socket manner.

11. The blending container of claim 1, wherein the blending container is blow-molded.

12. A blending system comprising:
the blending container of claim 1; and
an immersion blender insertable into the blending container, the immersion blender comprising a blade and a bell surrounding at least a portion of the blade, wherein the concaved portion of the closed end directs foodstuff toward the blade of the immersion blender.

13. The blending system of claim 12, wherein the concaved portion is configured to allow the bell of the immersion blender to rotate on the concaved portion in a ball and socket manner.

14. A blending container configured for use with an immersion blender, the blending container comprising:
a bottom surface having a curved portion;
at least one sidewall, wherein the at least one sidewall extends from the bottom surface and defines a cavity and wherein the curved portion of the bottom surface extends into the cavity;
an open end opposite the bottom surface and including an annular rib;
an annular shoulder that tapers inwardly from the at least one sidewall to the annular rib.

15. The blending container of claim 14, where in the at least one sidewall includes three, four, five, six, seven, eight, nine, or ten sidewalls.

16. The blending container of claim 14, the at least one sidewall has a first circumference and the annular rib has a second circumference, wherein the first circumference is larger than the second circumference.

17. The blending container of claim 16, wherein the annular shoulder tapers inwardly from the first circumference to the second circumference.

18. The blending container of claim 14, the annular shoulder further comprising a curved portion and a tapered portion, wherein the curved portion connects the at least one sidewall to the tapered portion and the tapered portion connects the curved portion to the annular rib.

19. The blending container of claim 18, wherein an angle between the tapered portion of the annular shoulder and at least one sidewall is from 110-130 degrees as measured from an axis defined by the at least one sidewall.

20. The blending container of claim 18, wherein a length of the tapered portion of the annular shoulder and the curved portion of the annular shoulder together is from 10-20 mm.
